(19) United States
(12) Patent Application Publication
(10) Pub. No.: US 2008/0297021 A1
(43) Pub. Date: Dec. 4, 2008

(54) FILM-TYPE FILTER, PLASMA DISPLAY APPARATUS COMPRISING THE FILM-TYPE FILTER, AND METHOD OF MANUFACTURING THE PLASMA DISPLAY APPARATUS

(75) Inventors: Cha-Won Hwang, Suwon-si (KR); Sung-Yong Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/125,173

(22) Filed: May 22, 2008

(30) Foreign Application Priority Data
May 31, 2007 (KR) 2007-53413

(51) Int. Cl. H01J 61/40; H01J 17/49; H01J 9/02

(52) U.S. Cl. 313/112; 313/582; 445/24

(57) ABSTRACT

A film-type filter, a plasma display apparatus comprising the film-type filter, and a method of manufacturing the plasma display apparatus. The film-type filter includes: a base film, an external light reflection reduction layer disposed on a first side of the base film, and an electromagnetic wave shielding layer disposed on an opposing second side of the base film, which comprises an electromagnetic wave shielding unit and a grounding unit surrounding the electromagnetic wave shielding unit. At least a portion of the grounding unit is exposed, and extends around side surfaces of the external light reflection reduction layer and the base film. Portions of the external light reflection reduction layer and the base film are removed at a cutting line, to expose the grounding unit.

### CROSS-REFERENCE TO RELATED APPLICATION

This application claims the benefit of Korean Application No. 2007-53413, filed May 31, 2007, in the Korean Intellectual Property Office, the disclosure of which is incorporated herein by reference.

### BACKGROUND OF THE INVENTION

1. Field of the Invention

Aspects of the present invention relate to a film-type filter, a plasma display apparatus comprising the film-type filter, and method of manufacturing the plasma display apparatus.

2. Description of the Related Art

Plasma display apparatuses are flat panel display apparatuses that display an image using a plasma discharge phenomenon, and have attracted attention as next-generation flat display devices, due to their high brightness, high contrast, low latent image formation. Plasma display apparatuses can be manufactured to large sizes, small thicknesses, and wide viewing angles.

A plasma display apparatus generally includes a filter disposed in front of a plasma display panel, to increase optical characteristics of the plasma display panel, and to absorb electromagnetic waves. A glass filter is generally used as the filter. However, a glass filter is heavy and expensive. In order to address the drawbacks of glass filters, a film-type filter, which is directly attached to the front surface of the plasma display panel, has been studied.

However, since the film-type filter is directly attached to the front surface of the plasma display panel, the grounding of an electromagnetic wave shielding layer of the film-type filter is difficult to achieve.

### SUMMARY OF THE INVENTION

To address the above and/or other problems, aspects of the present invention provide a film-type filter, a plasma display apparatus comprising the film-type filter, and a method of manufacturing the plasma display apparatus.

According to an aspect of the present invention, there is provided a film-type filter comprising: a base film; an external light reflection reduction layer that is supported on a first side of the base film; and an electromagnetic wave shielding layer that is supported on an opposing second side of the base film, comprising an electromagnetic wave shielding unit, and a grounding unit surrounding the electromagnetic wave shielding unit. At least a portion of the grounding unit is exposed around side surfaces of the external light reflection reduction layer and the base film. Portions of the external light reflection reduction layer and the base film are removed at a cutting line, to form the side surfaces of the external light reflection reduction layer and the base film.

According to aspects of the present invention, the grounding unit may surround the electromagnetic wave shielding layer, and may be disposed along the edges of the electromagnetic wave shielding unit. An exposed portion of the grounding unit can surround the electromagnetic wave shielding unit.

According to aspects of the present invention, an adhesive material may be coated on a portion of an exposed surface of the grounding unit.

According to aspects of the present invention, the external light reflection reduction layer and the base film have substantially the same surface areas, and are aligned with each other.

According to aspects of the present invention, the electromagnetic wave shielding layer may have a surface area that is greater than the surface areas of the external light reflection reduction layer and the base film.

According to aspects of the present invention, the external light reflection reduction layer may include an anti-reflection layer and/or an anti-glare layer.

According to aspects of the present invention, the film-type filter may further comprise an adhesive layer on the electromagnetic wave shielding layer. The adhesive layer may comprise a material that selectively absorbs light of a predetermined wavelength range.

According to aspects of the present invention, the electromagnetic wave shielding unit may be mesh shaped.

According to aspects of the present invention, the electromagnetic wave shielding layer may have a plurality of metal layers or metal oxide layers, which are stacked together.

According to an aspect of the present invention, there is provided plasma display apparatus comprising: the film-type filter; and a plasma display panel having the film-type filter disposed on a front surface thereof.

According to an aspect of the present invention, there is provided a method of manufacturing a plasma display apparatus, comprising: perforating a first film to divide the first film into inner an outer regions, the first film comprising a light reflection reduction layer disposed on a first base film; combining a second film comprising a second base film, an adhesive layer disposed on the second base film, and an electromagnetic wave shielding layer disposed on the adhesive layer, with the first film, such that the electromagnetic wave shielding layer is disposed upon the first base film, to form a film type filter; removing the second base film from the film-type filter, and attaching the film-type filter to the front surface of a plasma display panel, using the adhesive layer; and removing the outer region of the first base film.

According to aspects of the present invention, the electromagnetic wave shielding layer may comprise: an electromagnetic wave shielding unit; and a grounding unit that surrounds the electromagnetic wave shielding unit. Perforations may be formed in the first film, to correspond to the grounding unit.

According to another aspect of the present invention, there is provided a plasma display apparatus that comprises a plasma display panel that realizes an image, and a film-type filter that is directly attached to an image display surface of the plasma display panel. The film-type filter comprises: a base film; an electromagnetic wave shielding layer that is supported by the base film, on a side of the plasma display panel, and comprises an electromagnetic wave shielding unit and a grounding unit surrounding the electromagnetic wave shielding unit; and a light reflection reduction layer that is supported on an opposite side of the base film. At least a portion of the grounding unit extends past side surfaces of the external light reflection reduction layer and the base film, and is exposed. The side surfaces of the light reflection reduction layer and the base film are formed by tearing away portions of the anti-glare layer and the base film at a perforation.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is an exploded perspective view of a film-type filter, according to an exemplary embodiment of the present invention;

FIG. 2 is a plan view of the film-type filter of FIG. 1;

FIG. 3 is a cross-sectional view taken along line III-III of FIG. 1;

FIG. 4 is a magnified view of portion A of FIG. 1;

FIG. 5 is a modified version of the film-type filter of FIG. 1, according to an exemplary embodiment of the present invention;

FIG. 6 is a schematic perspective view of a plasma display apparatus comprising the film-type filter of FIG. 1, according to an exemplary embodiment of the present invention; and

FIGS. 7A through 7H are drawings illustrating a method of manufacturing a plasma display apparatus, according to an embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of present invention, by referring to the figures. As referred to herein, when a first element is said to be “disposed” on, or adjacent to, a second element, the first element can directly contact the second element, or can be separated from the second element by one or more other elements can be located therebetween.

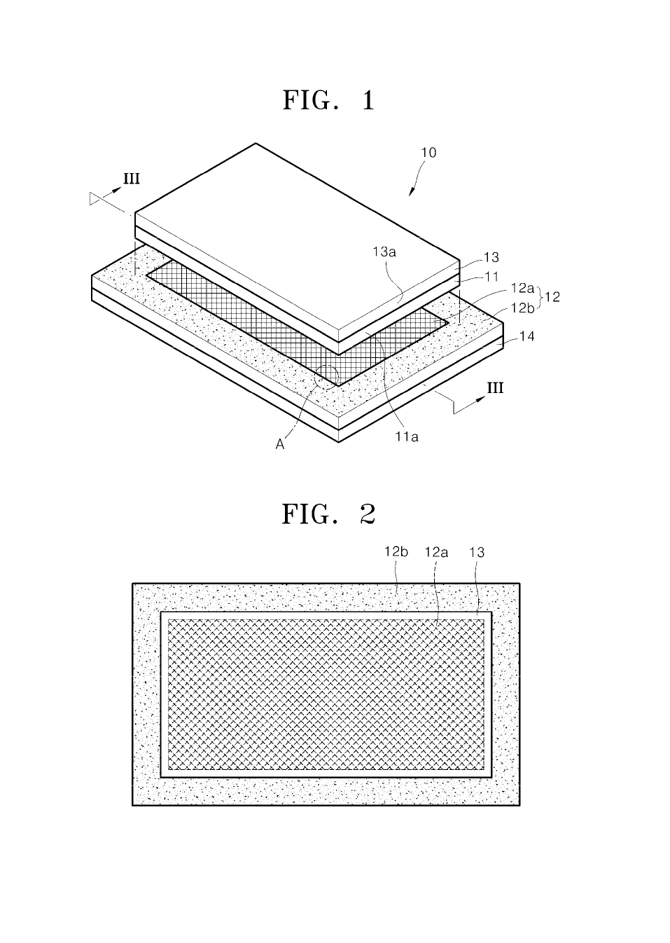

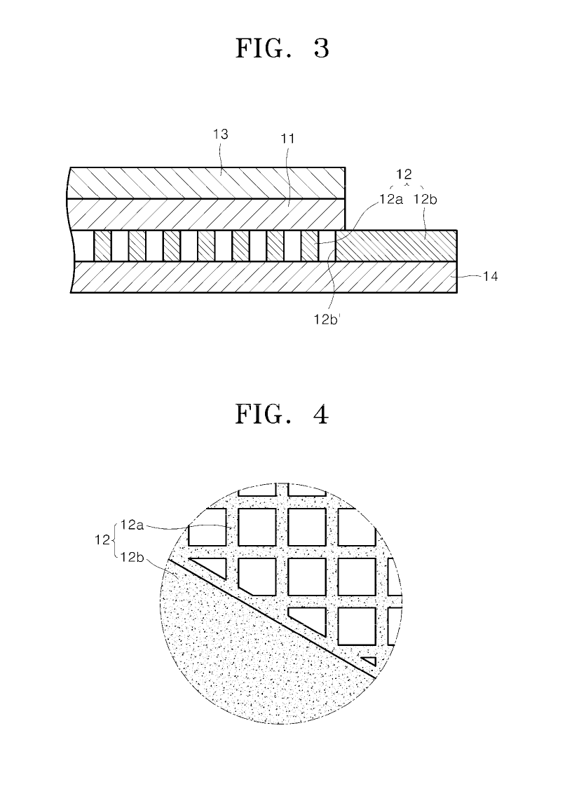

Referring to FIGS. 1 through 4, a film-type filter 10 is shown. FIG. 1 is an exploded perspective view of the film-type filter 10, according to an exemplary embodiment of the present invention. FIG. 2 is a plan view of the film-type filter 10 of FIG. 1. FIG. 3 is a cross-sectional view taken along line III-III of FIG. 1, and FIG. 4 is a magnified view of portion A of FIG. 1.

The film-type filter 10 includes a base film 11, an electromagnetic wave shielding layer 12, an external light reflection reduction layer 13, and an adhesive layer 14. Referring to FIGS. 1 through 3, the base film 11 is substantially rectangular, and can be formed of one selected from the group consisting of polyethersulphone (PES), polyacrylate (PAR), polyetherimide (PEI), polyethyelenen napthalate (PEN), polyethyeleneterepthalate (PET), (polyphenylene sulfide (PPS), polyallylate, polyimide, polycarbonate (PC), triacetyl cellulose (TAC), and cellulose acetate propinonate (CAP).

The external light reflection reduction layer 13 is formed in front of the base film 11. The external light reflection reduction layer 13 can be an anti-glare layer, or a reflection reduction layer. However, both of the anti-glare layer and the reflection reduction layer can be formed on the base film 11. In the film-type filter 10 of FIG. 1, the external light reflection reduction layer 13 is an anti-glare layer. The anti-glare layer scatters incident external light, at a surface of the external light reflection reduction layer 13, and prevents ambient light of the film-type filter 10 from being illuminated onto a surface of the film-type filter 10. When an anti-glare layer is formed on a conventional reinforced glass filter, due to a space between a plasma display panel and the conventional reinforced glass filter, definition of an image is reduced. Thus, it is difficult to apply the anti-glare layer to the conventional reinforced glass filter.

However, the anti-glare layer can be applied to the film-type filter 10, since the film-type filter 10 can be directly attached to the plasma display panel. The external light reflection reduction layer 13 can include a hard coating material. The hard coating material protects the film-type filter 10 from being scratched. The external light reflection reduction layer 13 has a thickness of about 2 to 7 μm, and has a hardness of about 2 to 3H, however, the present invention is not limited thereto.

The external light reflection reduction layer 13 and the base film 11 have substantially the same surface area, and are aligned with each other. Thus, side surfaces 13a of the external light reflection reduction layer 13, and side surfaces 11a of the base film 11, are disposed flush with each other. In other words, edges of the external light reflection reduction layer 13 and the base film 11 are aligned with each other.

The electromagnetic wave shielding layer 12 is formed on a rear surface of the base film 11. The electromagnetic wave shielding layer 12 includes an electromagnetic wave shielding unit 12a that absorbs electromagnetic waves generated from the plasma display panel, and a grounding unit 12b surrounding the electromagnetic wave shielding layer 12a.

Referring to FIG. 4, the electromagnetic wave shielding unit 12a has a rectangular mesh structure. However, the present invention is not limited thereto, and thus, the electromagnetic wave shielding unit 12a can have different shapes. The electromagnetic wave shielding layer 12 may be formed of copper or aluminum.

The electromagnetic wave shielding layer 12 can include a single layer, for example, a metal layer, or a metal oxide layer. The electromagnetic wave shielding layer 12 can include multiple layers, for example, 3 to 11 layers of the metal layer, and/or the metal oxide layer. The metal layer can be formed of palladium, copper, platinum, rhodium, aluminum, iron, cobalt, nickel, zinc, ruthenium, tin, tungsten, iridium, lead, or silver. The metal oxide layer can be formed of tin oxide, indium oxide, antimony oxide, zinc oxide, zirconium oxide, titan oxide, magnesium oxide, silicon oxide, aluminum oxide, metal alkoxide, indium tin oxide (ITO), or antimony tin oxide (ATO).

Referring to FIGS. 1 through 3, the electromagnetic wave shielding layer 12 has a greater surface area than that of the external light reflection reduction layer 13 and/or the base film 11. The side surfaces 13a of the external light reflection reduction layer 13 and the side surfaces 11a of the base film 11 are disposed inside of the grounding unit 12b, of the electromagnetic wave shielding layer 12. However, the side surfaces 13a of the external light reflection reduction layer 13, and the side surfaces 11a of the base film 11, can both be disposed flush with an inner surface 12b′ of the grounding unit 12b.

In the manufacturing process, the external light reflection reduction layer 13 and the base film 11 initially have the same surface area as the electromagnetic wave shielding layer 12. However, edge portions of the electromagnetic wave shielding layer 12 are removed, to expose the grounding unit 12b of the electromagnetic wave shielding layer 12. The side surfaces 11a and 13a, of the base film 11 and the external light reflection reduction layer 13, are formed by the removal of the edge portions. The side surfaces 11a and 13a can be cleanly cut, or can have a surface roughness, due to being torn along a cutting line (not shown). The cutting line can be formed from perforations. An adhesive material (not shown) can be coated on a portion of the surface of the exposed grounding unit 12b, and can be used to combine the base film 11 and the electromagnetic wave shielding layer 12. The adhesive material can be exposed, due to the removal of the base film 11.

In the film-type filter 10 of FIG. 1, a grounding area can be formed, when the grounding unit 12b is exposed. Thus, the electromagnetic wave shielding layer 12 can be readily grounded.

The adhesive layer 14 is formed on a rear surface of the electromagnetic wave shielding layer 12. The adhesive layer 14 is used to attach the film-type filter 10 to the plasma display panel. The adhesive layer 14 can include a material that selectively absorbs light having a predetermined wavelength range, such as, near infrared light. The adhesive layer 14 can also absorb visible light having a wavelength of approximately 585 nm, which is generated by a neon discharge gas, or can absorb light having a particular wavelength, in order perform to color correction.

The film-type filter 10 can have an overall transmittance of about 20 to 90%. The film-type filter 10 can have a haze of about 1 to 11%, due to the above-described structure.

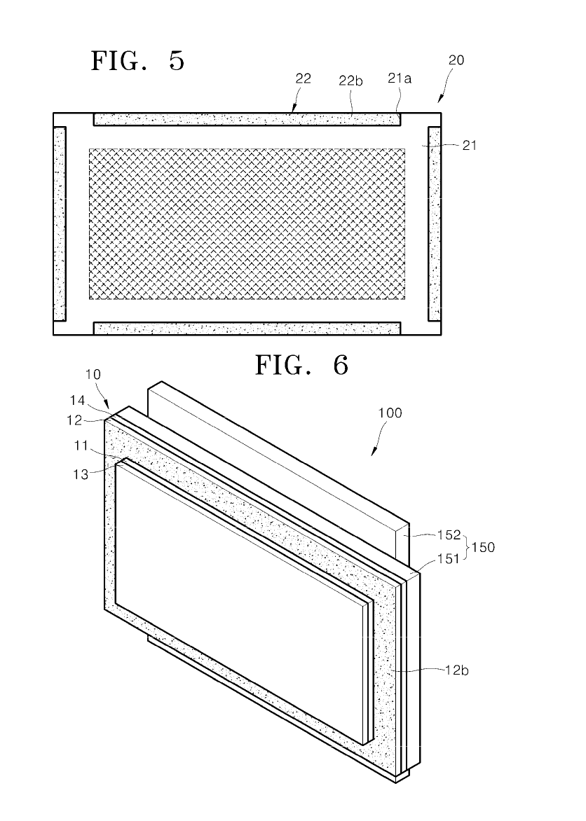

FIG. 5 shows a film-type filter 20, which is a modified version of the film-type filter 10 of FIG. 1, according to an exemplary embodiment of the present invention. For convenience of explanation, the external light reflection reduction layer 13 is not included in the film-type filter 20 of FIG. 5. A difference between the film-type filter 20 and the film-type filter 10 is that a base film 21 of the film-type filter 20 does not have a rectangular shape. That is, the base film 21 has cut portions 21a at edges thereof. The cut portions 21a expose grounding units 22b of an electromagnetic wave shielding layer 22. Accordingly, a grounding area of the electromagnetic wave shielding layer 22 is exposed, to facilitate grounding of the electromagnetic wave shielding layer 22.

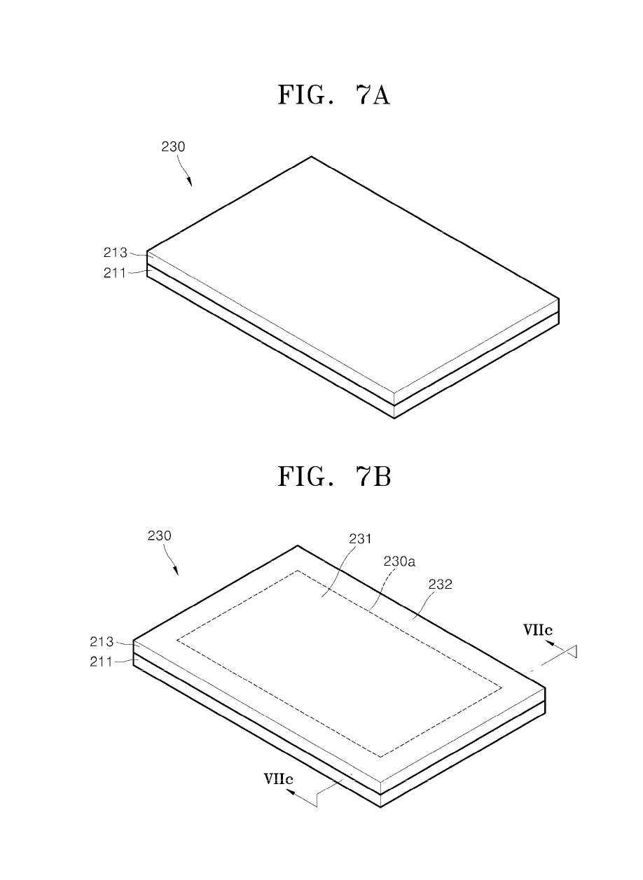

FIG. 6 is a schematic perspective view of a plasma display apparatus 100 comprising the film-type filter 10, according to an exemplary embodiment of the present invention. The plasma display apparatus 100 includes the film-type filter 10 and a plasma display panel 150. The plasma display panel 150 displays an image using a plasma discharge, and includes a front panel 151 and a rear panel 152, which are combined with each other. The plasma display panel 150 can have various internal structures, and thus, a detailed description thereof is omitted.

The film-type filter 10 is directly attached to a front surface of the front panel 151, using the adhesive layer 14. The grounding unit 12b of the film-type filter 10 is exposed, and other constituent elements of the plasma display apparatus 100 are electrically connected to the grounding unit 12b, thus, the electromagnetic wave shielding layer 12 can be readily grounded.

The plasma display apparatus 100 can further include: a chassis (not shown) that is disposed on a rear of the plasma display panel 150, to fix the plasma display panel 150; a circuit unit (not shown) that is disposed on a rear of the chassis, to drive the plasma display panel 150; and a case (not shown) that houses the plasma display panel 150, the chassis (not shown), and the circuit unit (not shown). The grounding unit 12b can be electrically connected to the chassis (not shown), or to the case (not shown), to ground the electromagnetic wave shielding layer 12.

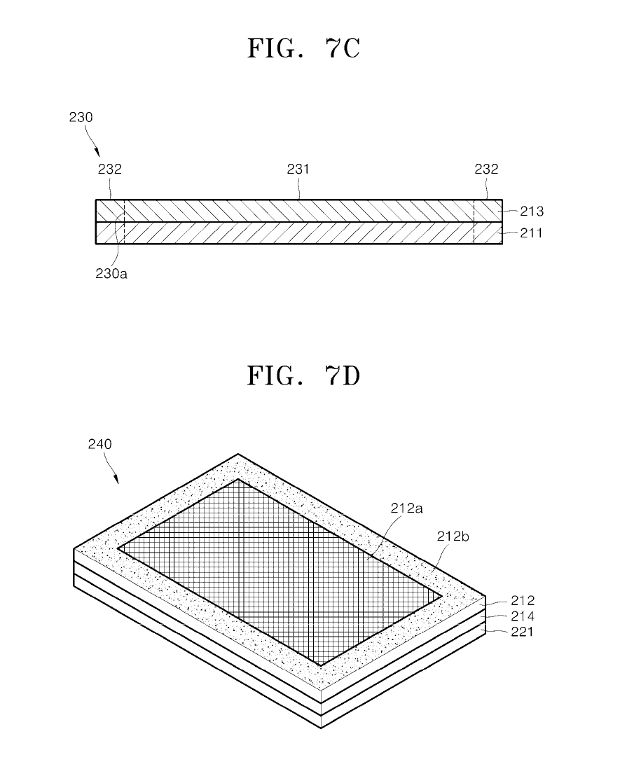

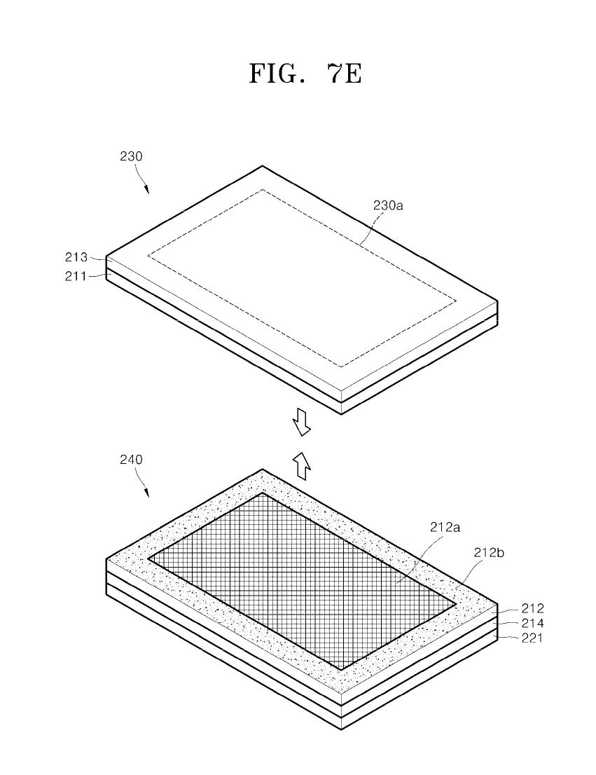

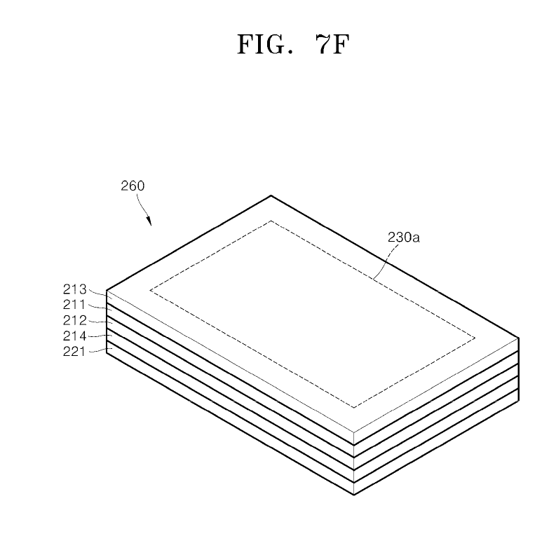

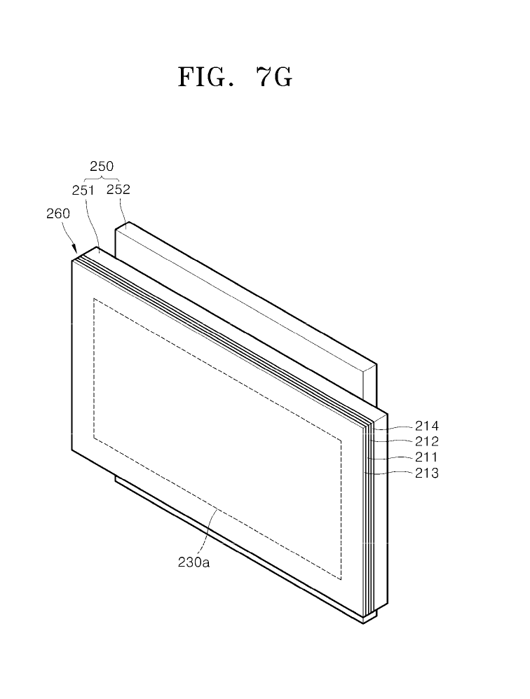

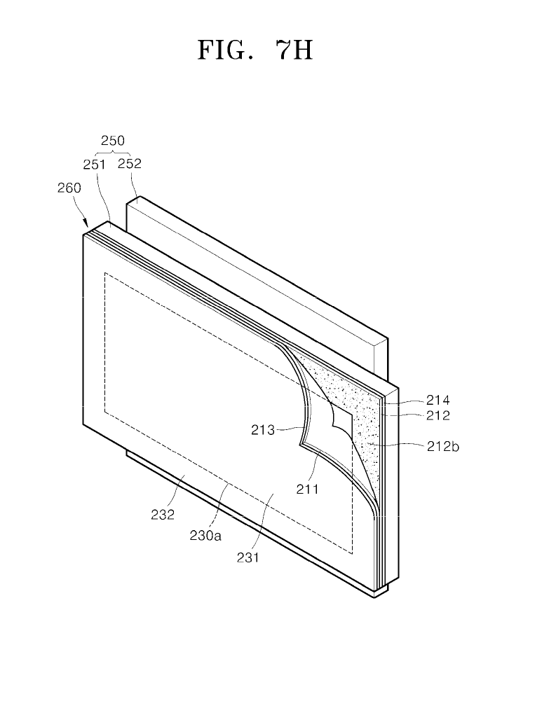

A method of manufacturing a plasma display apparatus 250, according to an exemplary embodiment of the present invention, will now be described with reference to FIGS. 7A through 7H. Referring to FIG. 7A, a first film 230 is prepared. The first film 230 includes a first base film 211 and an external light reflection reduction layer 213 disposed on the first base film 211. Afterwards, a cutting line 230a is formed in the first film 230, close to edges of the first film 230, by perforating the first base film 211 and the external light reflection reduction layer 213. The cutting line 230a can include minute holes (perforations) formed with a predetermined pitch. The first film 230 is divided into a central region 231 and an edge region 232, by the cutting line 230a. FIG. 7B is a perspective view of the first film 230 on which the cutting line 230a is formed, and FIG. 7C is a cross-sectional view taken along line VIIc-VIIc of FIG. 7B.

Referring to FIG. 7D, a second film 240 is prepared. The second film 240 includes a second base film 221, an adhesive layer 214 formed on the second base film 221, and an electromagnetic wave shielding layer 212 formed on the adhesive layer 214. The electromagnetic wave shielding layer 212 includes an electromagnetic wave shielding unit 212a and a grounding unit 212b surrounding the electromagnetic wave shielding unit 212a.

As depicted in FIG. 7E, the electromagnetic wave shielding layer 212 of the second film 240 and the first base film 211 of the first film 230 are combined to face each other. The combining of the electromagnetic wave shielding layer 212 and the first base film 211 can be performed using an additional adhesive, or the electromagnetic wave shielding layer 212 can be combined with the first base film 211, when the adhesive layer 214 is exposed through the electromagnetic wave shielding unit 212a. As a result of combining of the first film 230 and the second film 240, as depicted in FIG. 7F, a film-type filter 260 is completed. At this point, the cutting line 230a is formed to correspond to the grounding unit 212b.

Referring to FIG. 7G, after removing the second base film 221 from the film-type filter 260, the film-type filter 260 is attached to the front surface of the plasma display panel 250. The plasma display panel 250 includes a front panel 251 and a rear panel 252, which are coupled to each other.

As depicted in FIG. 7H, the edge region 232 of the first film 230 is removed from the film-type filter 260, at the cutting line 230a. In this process, a rough-cut surface can be formed on surfaces of the external light reflection reduction layer 213 and the first base film 211. An adhesive material (not shown) can be coated on a portion of the exposed surface of the grounding unit 212b of the electromagnetic wave shielding layer 212. The adhesive material joins the first film 230 with the second film 240, and the adhesive material is exposed, by removing a portion of the first film 230. Thus, the electromagnetic wave shielding layer 212 can be readily grounded, by connecting a ground to the exposed grounding unit 212b.

In a film-type filter of a plasma display apparatus, according to aspects of the present invention, an electromagnetic wave shielding layer is exposed, such that the electromagnetic wave shielding layer is readily grounded. In particular, since the film-type filter can include only one base film, manufacturing of the plasma display apparatus is easy, thereby reducing manufacturing costs.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A filter comprising:
a base film;
a light reflection reduction layer disposed on a first side of the base film; and
an electromagnetic wave shielding layer disposed on an opposing second side of the base film, comprising an electromagnetic wave shielding unit, and a grounding unit surrounding the electromagnetic wave shielding unit,
wherein at least a portion of the grounding unit extends over side surfaces of the light reflection reduction layer and the base film, and is exposed outside the light reflection reduction layer and the base film, and the side surfaces of the light reflection reduction layer and the base film are formed by removing portions of the light reflection reduction layer and the base film.

2. The filter of claim 1, wherein the grounding unit surrounds the electromagnetic wave shielding layer, and is disposed along the edges of the electromagnetic wave shielding unit.

3. The filter of claim 2, wherein an adhesive material is coated on a portion of an exposed surface of the grounding unit.

4. The filter of claim 1, wherein the light reflection reduction layer and the base film have substantially equal surface areas, and are aligned with each other.

5. The filter of claim 1, wherein the electromagnetic wave shielding layer has a greater surface area than the light reflection reduction layer and the base film.

6. The filter of claim 1, further comprising an adhesive layer on the electromagnetic wave shielding layer.

7. The filter of claim 6, wherein the adhesive layer comprises a material that selectively absorbs light of a predetermined wavelength range.

8. A plasma display apparatus comprising:
a plasma display panel; and
the filter of claim 1, disposed on a front surface of the plasma display panel.

9. A method of manufacturing a plasma display apparatus, comprising:
perforating a first film to divide the first film into inner and outer regions, the first film comprising a light reflection reduction layer disposed on a first base film;
combining a second film comprising a second base film, an adhesive layer disposed on the second base film, and an electromagnetic wave shielding layer disposed on the adhesive layer, with the first film, such that the electromagnetic wave shielding layer is disposed on the first base film, to form a filter;
removing the second base film from the filter, and attaching the filter to a front surface of a plasma display panel, using the adhesive layer; and
removing the outer region of the first base film.

10. The method of claim 9, wherein the electromagnetic wave shielding layer comprises:
an electromagnetic wave shielding unit; and
a grounding unit surrounding the electromagnetic wave shielding unit, and disposed along the edges of the electromagnetic wave shielding unit.

11. The method of claim 10, wherein the outer region corresponds to the grounding unit.

12. A plasma display apparatus that comprises a plasma display panel to form an image and a filter that is directly attached to a display surface of the plasma display panel, the filter comprising:
a base film;
an electromagnetic wave shielding layer disposed on a first side the base film comprising an electromagnetic wave shielding unit and a grounding unit surrounding the electromagnetic wave shielding unit; and
a light reflection reduction layer that is supported on an opposing second side of the base film,
wherein a portion of the grounding unit extends past side surfaces of the light reflection reduction layer and the base film, and is exposed outside of the light reflection reduction layer and the base film, and the side surfaces of the light reflection reduction layer and the base film are formed by removing portions of the light reflection reduction layer and the base film.

13. The filter of claim 1, wherein the light reflection reduction layer has a thickness of about 2 to 7 μm.

14. The filter of claim 1, wherein the light reflection reduction layer has a hardness of about 2 to 3H.

15. The filter of claim 1, wherein the electromagnetic wave shielding unit is a rectangular mesh.

16. The filter of claim 1, wherein the filter has an overall transmittance of about 20 to 90%.

17. The filter of claim 1, wherein the filter has a haze of about 1 to 11%.

18. The filter of claim 1, wherein the light reflection reduction layer comprises at least one of an anti-reflection layer and an anti-glare layer.

19. The filter of claim 6, wherein the adhesive layer absorbs near infrared light, and/or visible light having a wavelength of approximately 585 nm.

20. The filter of claim 6, wherein the adhesive layer performs color correction.
